(19) United States
(12) Patent Application Publication
(10) Pub. No.: US 2005/0236409 A1
(43) Pub. Date: Oct. 27, 2005

(54) Microwave oven

(75) Inventor: Sung Wook Cho, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/041,245

(22) Filed: Jan. 25, 2005

(30) Foreign Application Priority Data
Apr. 8, 2004 (KR) 2004-23948

(51) Int. Cl. H05B 6/64

(52) U.S. Cl. 219/757

(57) ABSTRACT

A microwave oven, in which a motor for rotating a turntable has an improved structure. The motor of the microwave oven includes a casing provided with an opened surface, a stator and a rotor, installed in the casing, a cover combined with the opened surface of the casing, and a protective cover closing a gap between the cover and the casing. The microwave oven prevents foreign substances from being introduced into the casing of the motor to prevent defects of the motor.

### CROSS-REFERENCE TO RELATED APPLICATION

This application claims the benefit of Korean Patent Application No. 2004-23948, filed Apr. 8, 2004, in the Korean Intellectual Property Office, the disclosure of which is incorporated herein by reference.

### BACKGROUND OF THE INVENTION

1. Field of the Invention

The present invention relates to a microwave oven, and, more particularly, to a microwave oven, in which a motor to rotate a turntable has an improved structure.

2. Description of the Related Art

A conventional general microwave oven comprises a turntable rotatably installed in a cooking chamber, and a motor to rotate the turntable that is installed on the outer bottom surface of the cooking chamber. Such a motor generally includes a casing provided with an opened surface, a cover to close the opened surface of the casing, and a stator and a rotor respectively installed in the casing.

Since the above motor of the microwave oven is exposed to a space under the cooking chamber, in which cooling air is circulated, foreign substances in the air circulating in the space under the cooking chamber may be introduced into the motor through a gap between the casing and the cover. A resulting contamination of the motor by the foreign substances may cause the motor to break down over a long period.

Particularly, a wall-mounted type microwave oven, which is installed on an inner wall of a building, has a structure in which an exhaust route to exhaust gas or smoke, generated from the inside of a kitchen, to the outside may be installed in a lower part of a main body, and a motor to rotate a turntable may be exposed to the gas or smoke passing through the exhaust route to cause frequent defects of the motor.

### SUMMARY OF THE INVENTION

Therefore, an aspect of the present invention provides a microwave oven, which prevents foreign substances from being introduced into a casing of a motor to rotate a turntable and which prevents defects of the motor as a result.

In accordance with another aspect of the present invention, the present invention provides a microwave oven having a motor to rotate a turntable that is positioned in a cooking chamber. The motor comprises a casing provided with an opened surface; a stator and a rotor that are respectively installed in the casing; a cover to cover the opened surface of the casing; and a protective cover to close a gap between the cover and the casing.

The protective cover may include a first cover unit to cover an outer surface of the cover; and a second cover unit extended and bent from the edge of the first cover unit to cover an outer circumference of the casing.

The motor may further comprise a rotary shaft to pass through the cover and protective cover and to be extended outward so as to transmit the rotary force of the motor to the outside.

The motor may be installed on the lower end of the outer surface of the cooking chamber such that the cover of the motor faces a bottom plate of the cooking chamber.

The microwave oven may comprise an exhauster to exhaust a kitchen space, and to be installed on an inner wall of a building.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view of a microwave oven in accordance with the present invention;

FIG. 2 is a cross-sectional view illustrating an internal structure of the microwave oven in accordance with the present invention;

FIG. 3 is a cross-sectional view illustrating the constitution and installation structure of a motor of the microwave oven in accordance with the present invention; and

FIG. 4 is an exploded perspective view illustrating the motor and a protective cover of the microwave oven in accordance with the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

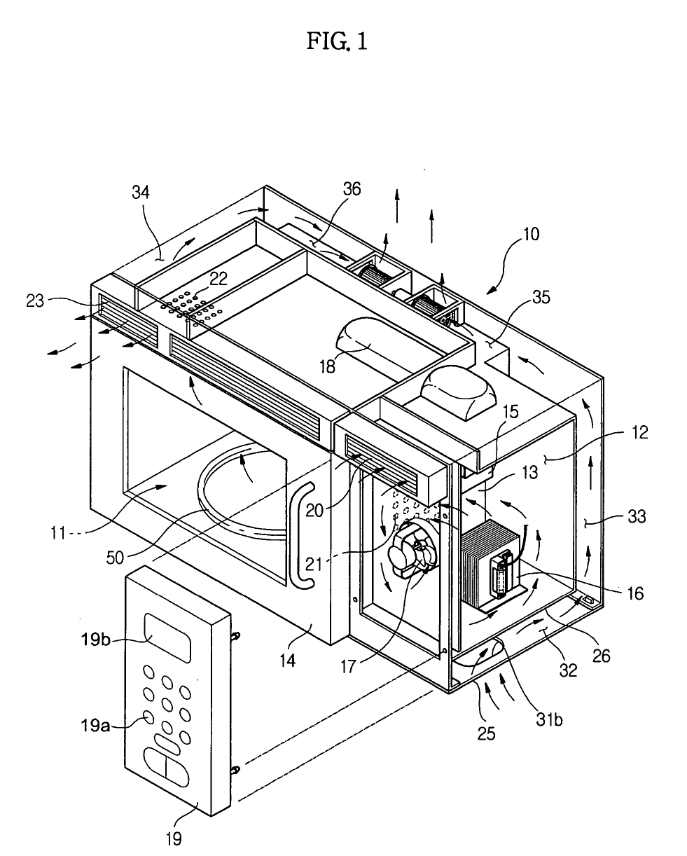

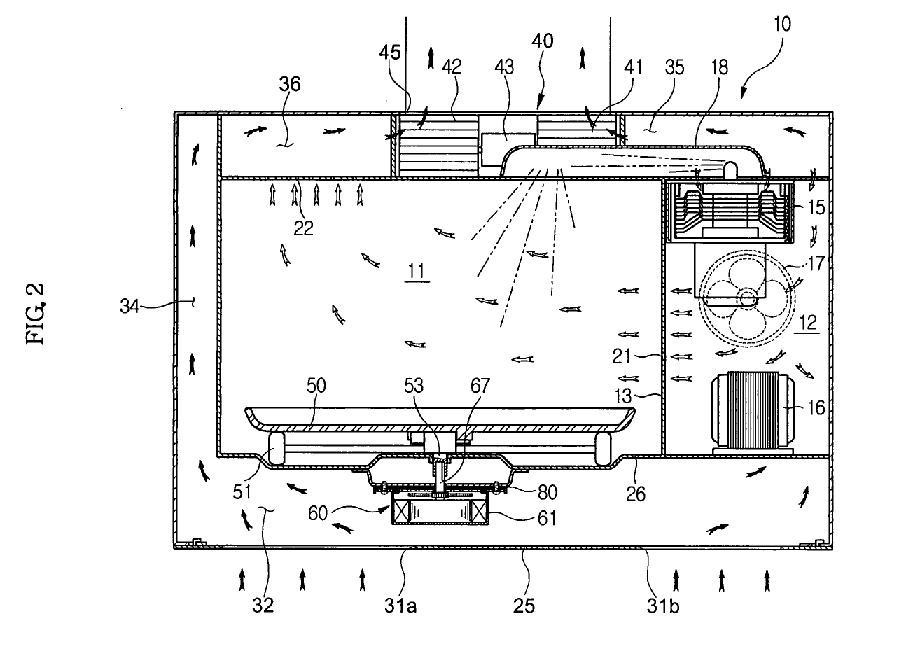

As shown in FIGS. 1 and 2, a microwave oven of the present invention comprises a main body 10 including a cooking chamber 11 to cook food therein and an electric component chamber 12 to accommodate various electric components. Although not shown in the drawings, a rear surface of the main body 10 is fixed to an inner wall of a kitchen in which a gas oven range is installed.

The main body 10 is divided into the cooking chamber 11 and the electric component chamber 12 by a partition 13.A door 14 is rotatably attached to a front surface of the cooking chamber 11 to open and close the cooking chamber 11. A magnetron 15 to supply high-frequency waves to the cooking chamber 11, a high-pressure transformer 16 to apply a high voltage to the magnetron 15, and a cooling fan 17 to cool the inside of the electric component chamber 12 are installed in the electric component chamber 12.

A waveguide 18 to guide the high-frequency waves supplied from the magnetron 15 to the inside of the cooking chamber 11 is installed on upper surfaces of the electric component chamber 12 and the cooking chamber 11. An operating panel 19, including a plurality of operating buttons 19a to control various operations of the microwave oven and a display unit 19b to display an operational state of the microwave oven, is installed on the front surface of the electric component chamber 12. A turntable 50, rotatably supported by a roller 51, to mount food on an upper surface thereof is installed in a lower portion of the cooking chamber 11, and a motor 60 to rotate the turntable 50 is installed at a lower portion of the outer surface of the cooking chamber 11.

The microwave oven of the present invention further comprises a ventilating route to cool the electric component chamber 12 and to ventilate the cooking chamber 11 therethrough, an exhaust route to exhaust gas or smoke that is generated from a portion of the lower part of the main body 10 adjacent to the gas oven range (or the kitchen) to the outside therethrough, and an exhauster 40 to blow the gas or smoke that is guided through the exhaust route to the outside.

The ventilating route includes a front inlet 20 that is installed on the front surface of the main body 10 above the operating panel 19. The front inlet 20 communicates with the inside of the electric component chamber 12. A plurality of through holes 21 formed through the partition 13 that divides the main body 10 into the cooking chamber 11 and the electric component chamber 12. Meanwhile, a plurality of through holes 22 are formed through the upper surface of the cooking chamber 11, and a front outlet 23 is installed on the upper part of the front surface of the cooking chamber 11 of the main body 10. The ventilating route cools the components in the electric component chamber 12 using air, which is introduced into the electric component chamber 12 through the front inlet 20 when the cooling fan 17 in the electric component chamber 12 is operated, and then allows the air to be introduced into the cooking chamber 11 through the through holes 21 of the partition 13 to ventilate the cooking chamber 11. Subsequently, the ventilating route allows the air in the cooking chamber 11 to be exhausted to the outside through the through holes 22 and the front outlet 23.

The exhaust route includes exhaust inlets 31a and 31b that are respectively formed through a bottom plate 25 of the main body 10, a lower route 32 that is formed along a separation gap between bottom plates 26 of the cooking chamber 11 and the electric component chamber 12 and the bottom plate 25 of the main body 10, a first elevating route 33 that is vertically formed along the rear part of the electric component chamber 12, a second elevating route 34 that is vertically formed along the side part of the cooking chamber 11, and first and second upper routes 35 and 36 that are respectively formed along the rear part of the upper portion of the main body 10. The first and second upper routes 35 and 36 respectively communicate with the first elevating route 33 and the second elevating route 34.

The above structure of the exhaust route causes gas or smoke, absorbed from the lower portion of the main body 10 through the exhaust inlets 31a and 31b, to be guided to the exhauster 40 that is positioned in the upper portion of the main body 10 through the lower route 32, the first and second elevating routes 33 and 34 and the first and second upper routes 35 and 36.

The exhauster 40 includes a first exhaust fan 41 to absorb air of the first upper route 35 and to exhaust the absorbed air to the outside, a second exhaust fan 42 to absorb air of the second upper route 36 and to exhaust the absorbed air to the outside, and a motor 43 to simultaneously operate the first and second exhaust fans 41 and 42. As shown in FIG. 2, an exhaust slot 45 to exhaust air blown through the exhauster 40 to the outside is formed through the upper portion of the main body 10 at the side in which the exhauster 40 is installed.

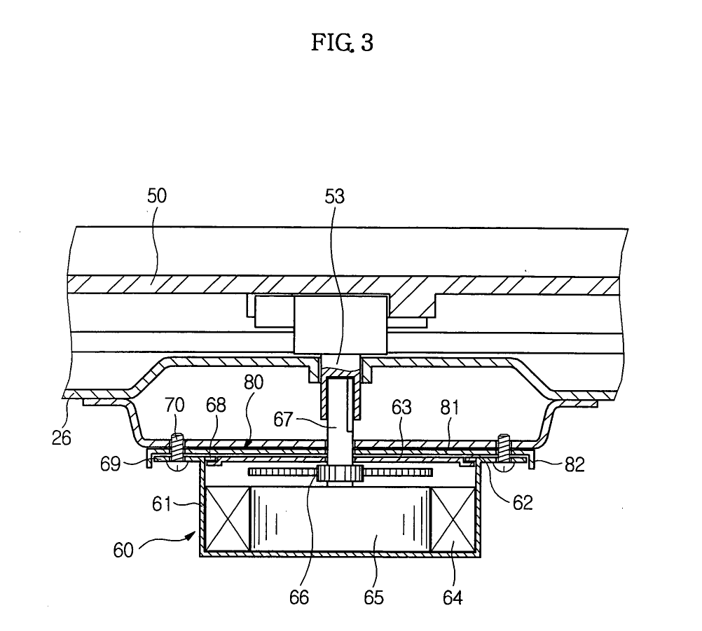

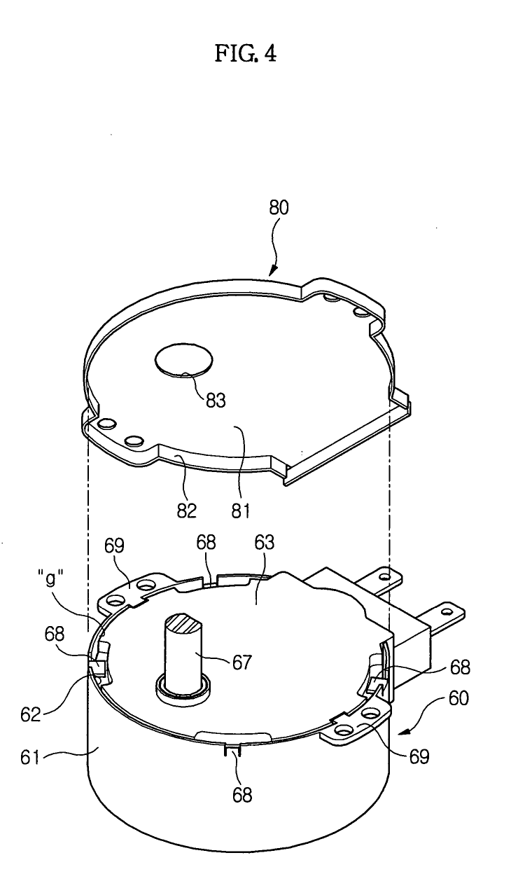

As shown in FIGS. 3 and 4, the motor 60 to rotate the turntable 50 in the cooking chamber 11 includes a cylindrical casing 61 provided with one opened surface 62 and other closed surfaces, a cover 63 connected to the opened surface 62 of the casing 61 so that the opened surface 62 is closed by the cover 63, a stator 64 installed in the casing 61, and a rotor 65 rotatably installed inside the stator 64. The motor 60 further includes a reduction gear 66 installed in the casing 61, and a rotary shaft 67 passing through the cover 63 and extended outward to transmit the rotary force of the reduction gear 66 to the outside.

The casing 61 serves to fix the motor 60 to the bottom plate 26 of the cooking chamber 11, and is provided with both screw connection portions 69, into which fixing screws 70 are respectively inserted. As shown in FIG. 4, the cover 63 of the motor 60 is combined with the casing 61 by bending a plurality of fasteners 68, formed on the circumference of the opened surface 62 of the casing 61, toward the cover 63 so that the edge of the cover 63 is supported by the fasteners 68, under the condition that the cover 63 is inserted into the opened surface 62 of the casing 61.

The motor 60 of the microwave oven of the present invention includes a protective cover 80 to prevent foreign substances from being introduced into the motor 60 through a gap (g) between the casing 61 and the cover 63 to prevent defects of the motor 60. The protective cover 80 coating the outer surface of the cover 63 is interposed between the bottom plate 26 of the cooking chamber 11 and the cover 63 when the motor 60 is fixed to the bottom plate 26 of the cooking chamber 11. As shown in FIGS. 3 and 4, the protective cover 80 includes a first cover unit 81 coating the overall outer surface of the upper part of the cover 63 and provided with a through hole 83, into which the rotary shaft 67 is inserted, and a second cover unit 82 extended from the edge of the first cover unit 81 to a designated length and then bent so that a part of the outer circumference of the casing 61 is coated by the second cover unit 82.

In the above structure of the protective cover 80, the first and second cover units 81 and 82 completely close the gap (g) between the casing 61 and the cover 63to prevent foreign substances from being introduced into the motor 60. That is, in the microwave oven of the present invention as shown in FIG. 2, the motor 60 is installed on the lower surface of the bottom plate 26 of the cooking chamber 11, thus being exposed to gas or smoke passing through the lower route 32. Here, the protective cover 80, which completely closes the gap (g) between the casing 61 and the cover 63 of the motor 60, prevents the above gas or smoke from being introduced into the motor 60 through the gap (g).

When the above-described motor 60 is installed on the lower surface of the bottom plate 26 of the cooking chamber 11, the motor 60 is attached to the bottom plate 26 of the cooking chamber 11 under the condition that the protective cover 80, which is positioned on the motor 60, closes the gap (g) between the casing 61 and the cover 63. Here, the rotary shaft 67, having passed through the protective cover 80 and extended upward, passes through the bottom plate 26 of the cooking chamber 11, enters into the cooking chamber 11, and is connected to a connecting member 53 to intermediate the connection between the motor 60 and the turntable 50.

Under the above described conditions, the fixing screws 70 are respectively inserted into the screw connection portions 69, to fix the motor 60 to the bottom plate 26 of the cooking chamber 11. Further, since the motor 60 is installed on the lower- surface of the bottom plate 26 of the cooking chamber 11 under the condition that the gap (g) between the casing 61 and the cover 63 of the motor 60 is completely closed by the protective cover 80, preventing the gas or smoke, which flows through the lower route 32 of the main body 10, from being introduced into the motor 60 is possible.

As is apparent from the above description, the present invention provides a microwave oven, in which a gap between a casing and a cover of a motor to rotate a turntable is closed by a protective cover, to prevent foreign substances from being introduced into the casing and being advantageous in that defects of the motor are prevented.

Although a few embodiments of the present invention have been shown and described, it would be appreciated by those skilled in the art that changes may be made in these embodiments without departing from the principles and spirit of the invention, the scope of which is defined in the claims and their equivalents.

1. A microwave oven having a motor, to rotate a turntable that is positioned in a cooking chamber, said motor comprising:
a casing provided with an opened surface;
a stator and a rotor respectively installed in the casing;
a cover to cover the opened surface of the casing; and
a protective cover to close a gap between the cover and the casing.

2. The microwave oven according to claim 1, wherein the protective cover comprises:
a first cover unit to cover an outer surface of the cover; and
a second cover unit extended and bent from the edge of the first cover unit cover an outer circumference of the casing.

3. The microwave oven according to claim 2, wherein the motor further comprises a rotary shaft passing through the cover and the protective cover and extended outwards so as to transmit the rotary force of the motor to the outside.

4. The microwave oven according to claim 1, wherein the motor further comprises a rotary shaft passing through the cover and the protective cover and extended outwards so as to transmit the rotary force of the motor to the outside.

5. The microwave oven according to claim 1, wherein the motor is installed on the lower end of the outer surface of the cooking chamber such that the cover of the motor faces a bottom plate of the cooking chamber.

6. The microwave oven according to claim 1, comprising an exhauster that is installed on an inner wall of a building to exhaust a kitchen.
